(19) United States
(12) Patent Application Publication
(10) Pub. No.: US 2014/0069982 A1
(43) Pub. Date: Mar. 13, 2014

(54) Labor-saving Stapler

(71) Applicant: Hongbo Zhao, Ninghai (CN)

(72) Inventor: Hongbo Zhao, Ninghai (CN)

(21) Appl. No.: 13/611,015

(22) Filed: Sep. 12, 2012

(51) Int. Cl. B25C 5/06

(52) U.S. Cl. 227/132

(57) ABSTRACT

a labor-saving stapler having a base, an anvil, a pair of frames, a top pin passing across the frames, a staple magazine, a first elastic element between the base and the staple magazine, a striker lever having a striker, a second elastic element between the staple magazine and the striker lever, a pressing lever, a roller pin passing across the lever frame, a roller covering on the roller pin and touching the striker lever, and a hand cover. The stapler is labor-saving and quiet.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a stationery stapler, and more particularly, to a stapler which is labor-saving and quiet in use.

2. Description of Related Art

Staplers are a common used stationery. It is used to staple a pile of papers up. A conventional labor-saving stapler has a base which is able to be placed on a plane, such as a table, an anvil formed on a front end of the base, a pair of frames formed on a rear end of the base, a rear pin passing across a rear portion of the pair of frames, a top pin passing across a top portion of the pair of frames, a staple magazine having a magazine rear pivotally linked to the rear pin and a magazine front containing staples, a striker lever having a striker rear also pivotally linked to the rear pin and a striker front having a striker for pressing a staple out from the staple magazine, a pressing lever having a lever rear pivotally linked either to the top pin or to the striker lever and a lever front which is able to be pressed down by a hand of a user, and a leverage provided between the striker lever and the pressing lever for saving labor of the user to press down the hand lever.

However, such stapler has some drawbacks. A contacting surface between the leverage and the striker lever is always a sliding pin fixed to the leverage. When the user press the pressing lever down, the sliding pin moves along the striker lever. Since the leverage effect, a pressure between the sliding pin and the striker lever is usually several times to that one the user applies to the hand lever. The great pressure always causes a huge friction between the sliding pin and the striker lever. The friction severely lowers a labor efficiency of the user and always cause a loud scraping noise.

### BRIEF SUMMARY OF THE INVENTION

The main object of the invention is to provide a labor-saving stapler having a high labor efficiency.

Another object of the invention is to provide a labor-saving stapler which is quiet in use.

In order to accomplish the above objects, the present invention provides a labor-saving stapler having a base, an anvil formed on a front end of the base, a pair of frames being formed on a rear end of the base and each having a rear hole and a top hole, a rear pin passing across the rear holes on the pair of frames, a top pin passing across the top holes on the pair of frames, a base cover on which the base is securely fixed, a staple magazine having a magazine rear pivotally linked to the rear pin and a magazine front, a first elastic element between the base and the staple magazine, a striker lever having a striker rear pivotally linked to the rear pin and a striker front having a striker, a second elastic element between the staple magazine and the striker lever, a pressing lever having a lever front, a lever rear with a pair of lever holes being defined therein and covering on the top pin and a pair of lever frames each having a lever frame hole, a roller pin passing across the lever frame holes in the pair of lever frames, a roller covering on the roller pin and touching the striker lever, and, a hand cover fixed to the pressing lever.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic perspective view of a preferred embodiment of the labor-saving stapler of the invention.

FIG. 2 is an exploded perspective view of the labor-saving stapler shown in FIG. 1.

FIG. 3 is a partially exploded perspective view of the labor-saving stapler shown in FIG. 1. And,

FIG. 4 is a partially side plane view of the labor-saving stapler shown in FIG. 1.

### DETAILED DESCRIPTION OF THE INVENTION

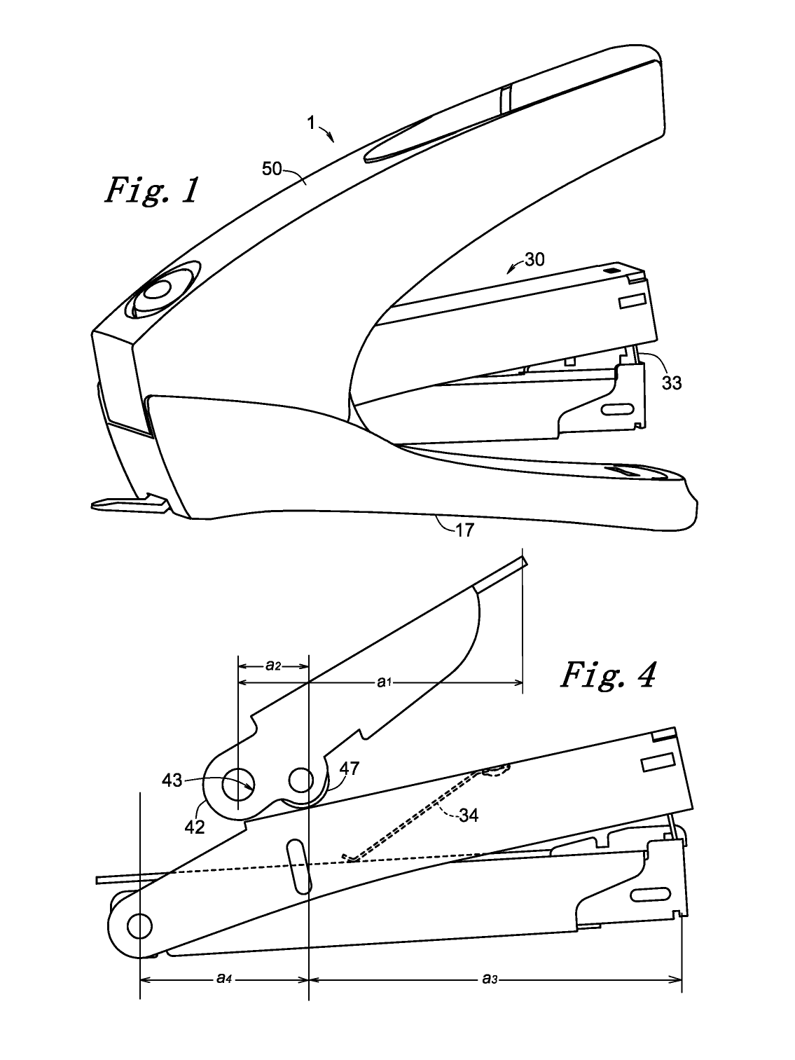

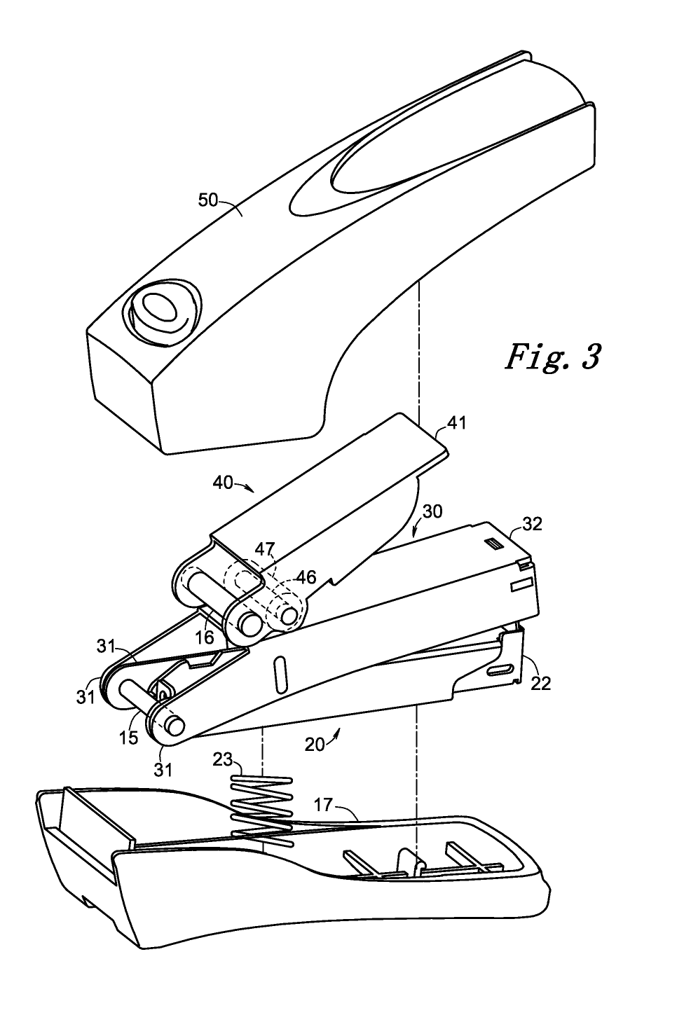

With reference to FIGS. 1, 2, 3 and 4, a labor-saving stapler 1 of the invention is shown. The labor-saving 1 has a base 10, an anvil 11 formed on a front end of the base 10, a pair of frames 12 being formed on a rear end of the base 10 and each having a rear hole 13 and a top hole 14, a rear pin 15 passing across the rear holes 13 on the pair of frames 12, a top pin 16 passing across the top holes 14 on the pair of frames 12, a base cover 17 on which the base 10 is securely fixed, a staple magazine 20 having a magazine rear 21 pivotally linked to the rear pin 15 and a magazine front 22 containing staples (not shown in the Figs.), a first elastic element 23 between the base 10 and the staple magazine 20, a striker lever 30 having a striker rear 31 also pivotally linked to the rear pin 15 and a striker front 32 having a striker 33 for pressing one staple out from the staple magazine 20, a second elastic element 34 between the staple magazine 20 and the striker lever 30, a pressing lever 40 having a lever front 41, a lever rear 42 with a pair of lever holes 43 being defined therein and covering on the top pin 16 and a pair of lever frames 44 each having a lever frame hole 45, a roller pin 46 passing across the lever frame holes 45 in the pair of lever frames 44, a roller 47 covering on the roller pin 46 and touching the striker lever 30, and a hand cover 50 fixed to the pressing lever 40.

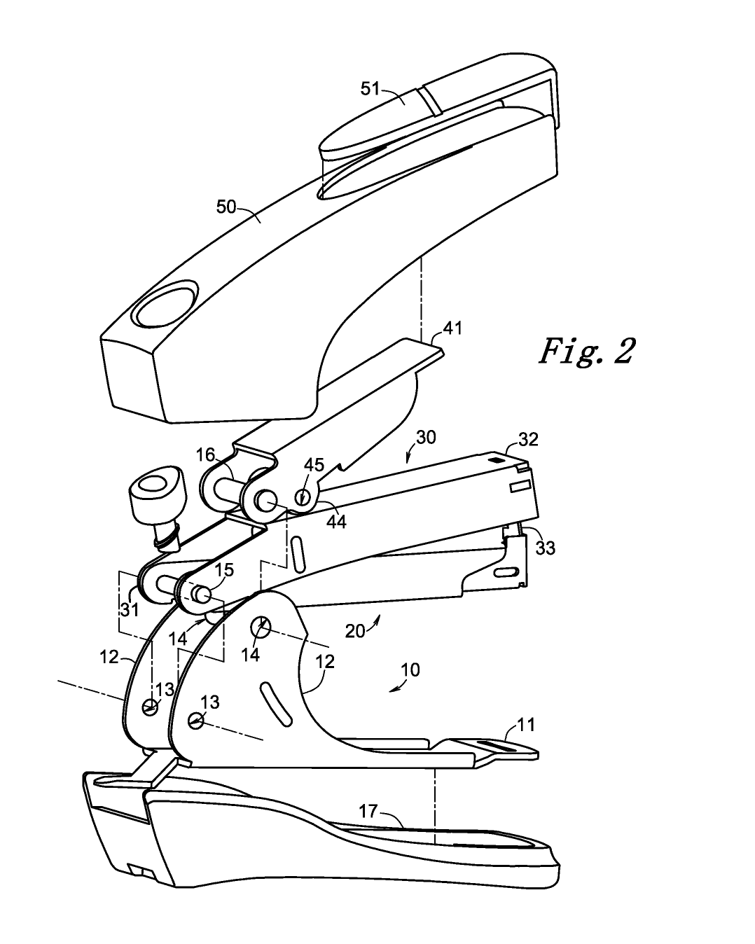

In use, the labor-saving stapler 1 of the invention is in a spare status as shown in FIGS. 1 and 2, in which the first and the second elastic elements 23 and 34 are fully expanded. The user is able to place a pile of papers needing to be stapled between the magazine front 22 and the anvil 11 and then press down the hand cover 50 against the first and the second elastic elements 23 and 34. The pressing lever 40 will rotate round the top pin 16, and the roller 47 will move downward accordingly. As the roller 47 rotates downward, the roller 47 rotates round the roller pin 46 and moves on the striker lever 30 downward to staple. After the stapling, the user is able to release the hand cover 50 and the first and the second elastic elements 23, 34 will respectively urge the staple magazine 20 and the striker lever 30 back to the spare status. The roller 47 anti-rotates and moves back on the striker lever 30. As especially shown in FIG. 2, a rubber pad 51 may be provided on the hand cover 50 for better feeling of touch of user's hand.

As shown in FIG. 4, an arm of a hand pressing force a1 is usually 10 times of an arm of a roller's 47 reaction force a2, and an arm of a stapling resistance a3 is usually 3 times of an arm of a roller's 47 pressing force a4. Therefore, a leverage effect of the labor-saving stapler is able to about 10/3 times. The roller 47 rotates on the striker lever 30 instead of slides. Therefore, the invention is much quiet in use. From above description, it could be seen that the labor-saving stapler has a high labor efficiency and at the same time, the roller 47 rotating on the striker lever 30 will significantly lowers noise in use and further increase the efficiency of labor saving than the conventional sliding leverages.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A labor-saving stapler comprising:
a base,
an anvil formed on a front end of the base,
a pair of frames being formed on a rear end of the base and each having a rear hole and a top hole,
a rear pin passing across the rear holes on the pair of frames,
a top pin passing across the top holes on the pair of frames,
a base cover on which the base is securely fixed,
a staple magazine having a magazine rear pivotally linked to the rear pin and a magazine front,
a first elastic element between the base and the staple magazine,
a striker lever having a striker rear pivotally linked to the rear pin and a striker front having a striker,
a second elastic element between the staple magazine and the striker lever,
a pressing lever having a lever front, a lever rear with a pair of lever holes being defined therein and covering on the top pin and a pair of lever frames each having a lever frame hole,
a roller pin passing across the lever frame holes in the pair of lever frames,
a roller covering on the roller pin and touching the striker lever, and,
a hand cover fixed to the pressing lever.
